(19) United States
(12) Patent Application Publication
(10) Pub. No.: US 2013/0219339 A1
(43) Pub. Date: Aug. 22, 2013

(54) METHOD AND SYSTEM FOR MANAGING SHARING OF CONTENT ON AN ONLINE SHARING PLATFORM

(71) Applicants: Jason WIESE, Pittsburgh, PA (US); Elizabeth F. CHURCHILL, San Francisco, CA (US); Judd ANTIN, Berkeley, CA (US)

(72) Inventors: Jason WIESE, Pittsburgh, PA (US); Elizabeth F. CHURCHILL, San Francisco, CA (US); Judd ANTIN, Berkeley, CA (US)

(73) Assignee: YAHOO! INC., Sunnyvale, CA (US)

(21) Appl. No.: 13/400,123

(22) Filed: Feb. 20, 2012

(51) Int. Cl. G06F 15/16; G06F 3/048

(52) U.S. Cl. 715/833; 709/204

(57) ABSTRACT

A method and system for managing sharing of content on an online sharing platform. The method includes receiving the content from a user to post on the online sharing platform, determining indicator position on one or more sliders associated with the content, acquiring preferences of the user based on the indicator position on the one or more sliders and displaying the content based on the preferences of the user. The system includes an electronic device that enables a user to provide content using one or more sliders. The system also includes a communication interface in electronic communication with the electronic device, a memory that stores instructions and a processor.

### TECHNICAL FIELD

Embodiments of the disclosure relate to the field of managing sharing of content by a user on an online sharing platform.

### BACKGROUND

In recent times, sharing platforms, for example networking sites, various publication platforms and various blogging sites on the internet are being widely utilized by users for communicating with each other. Examples of the networking sites include, but are not limited to, Facebook, Orkut, MySpace, Twitter, Instagram and Foursquare. The users of such sharing platforms can post content on the sharing platforms and further push the content into other sharing platforms. The content posted on the sharing platform can be viewed by multiple contacts present in a network of the user. Examples of the content include, but are not limited to a location information, an image, a user status, a relationship information, a user interest, a news feed and an experience of the user. When the user posts the content on the sharing platform, the content is recorded and further displayed on a web page of the sharing platform. The content displayed is thus viewed by the contacts present in the network of the user.

Typically, the user can create a profile on the sharing platform. The profile also includes a privacy setting that can be defined by the user. The privacy setting includes pre-specified rules that are used to decide the contacts of the user permitted to access the content. In one example, the privacy setting can be such that the user can explicitly mention the contacts for viewing the content. In another example, the privacy setting can be such that the user can explicitly mention the contacts excluded from viewing the content.

Further, the user can also create one or more groups, ahead of time, using the privacy setting. In one example, a group can include contacts connected to the user on a particular online service or website. The groups can include one or more contacts for viewing the content. The groups can also include one or more contacts excluded from viewing the content. However, the user is required to perform multiple alterations on the privacy settings to define the groups or contacts. Further, the user is required to navigate to different web pages of the sharing platform to set the privacy setting. Also, the user is unable to limit the sharing of the content on the sharing platform in real time based on a system computed proximity levels that include discrete scales and user defined proximity levels that include continuous scales, existing between the contacts and the user.

In another example, one or more services exist for filtering the contacts of the user based on different proximity levels. The filtered contacts are permitted to view the content posted by the user. However, the contacts filtered are based on system computed proximity levels and thus, restrains the user to manage sharing of the content based on the user-defined proximity levels.

In the light of the foregoing discussion there is a need for a method and a system for managing sharing of the content on an online sharing platform based on the system computed proximity levels and the user-defined proximity levels.

### SUMMARY

The above-mentioned needs are met by a method, a computer program product and a system for managing sharing of content on an online sharing platform.

An example of a method of managing sharing of content on an online sharing platform includes receiving the content from a user to post on the online sharing platform. The method also includes determining indicator position on one or more sliders associated with the content. The method further includes acquiring preferences of the user, from a database based on the indicator position on the one or more sliders. Further, the method includes displaying the content based on the preferences of the user.

An example of a computer program product stored on a non-transitory computer-readable medium that when executed by a processor, performs a method of managing sharing of content on an online sharing platform includes receiving the content from a user to post on the online sharing platform. The method also includes determining indicator position on one or more sliders associated with the content. The method further includes acquiring preferences of the user, from a database based on the indicator position on the one or more sliders. Further, the method includes displaying the content based on the preferences of the user.

An example of a system for managing sharing of content on an online sharing platform includes an electronic device that enables a user to provide the content using one or more sliders. The system also includes a communication interface in electronic communication with the electronic device. The system further includes a memory that stores instructions. Further the system includes a processor responsive to the instructions to receive the content from the user, determine indicator position on one or more sliders associated with the content, acquire preferences of the user based on the indicator position on the one or more sliders and display the content based on the preferences of the user on the electronic device.

### BRIEF DESCRIPTION OF THE FIGURES

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, in accordance with which various embodiments can be implemented;

FIG. 2 is a block diagram of a server, in accordance with one embodiment;

FIG. 3 is a flowchart illustrating a method of managing sharing of content on an online sharing platform, in accordance with one embodiment; and

FIG. 4 illustrates an exemplary view of managing sharing of content on an online sharing platform by a user, in accordance with one embodiment.

### DETAILED DESCRIPTION OF THE EMBODIMENTS

The above-mentioned needs are met by a method, computer program product and system for managing sharing of content on an online sharing platform by a user. The following detailed description is intended to provide example implementations to one of ordinary skill in the art, and is not intended to limit the invention to the explicit disclosure, as one or ordinary skill in the art will understand that variations can be substituted that are within the scope of the invention as described.

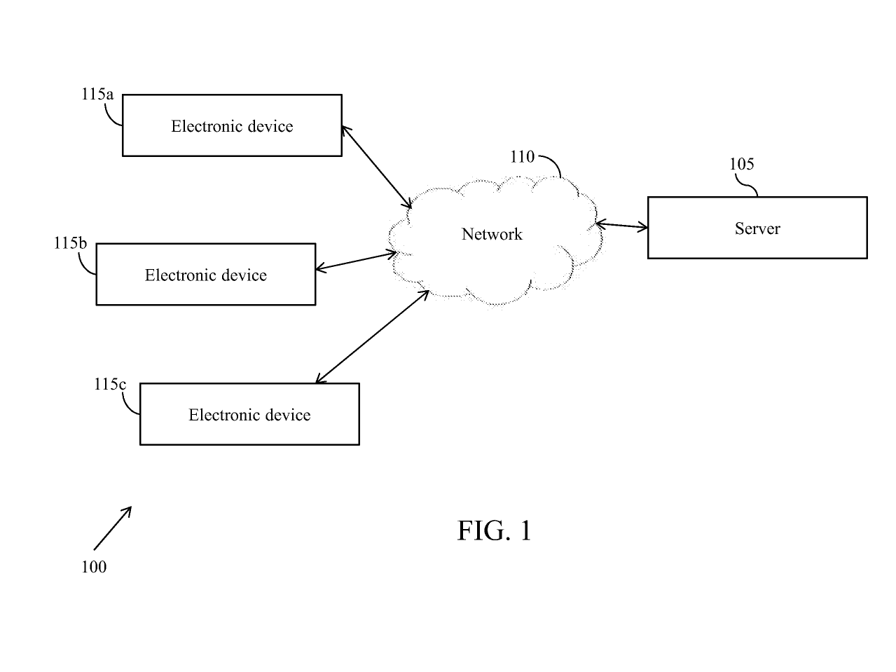

FIG. 1 is a block diagram of an environment 100, in accordance with which various embodiments can be implemented.

The environment 100 includes a server 105. The environment 100 further includes one or more electronic devices, for example an electronic device 115a, an electronic device 115b, and an electronic device 115c, which can communicate with the server 105 through a network 110. Examples of the electronic devices include, but are not limited to, computers, mobile devices, laptops, palmtops, hand held devices, telecommunication devices and personal digital assistants (PDAs).

The server 105 is in electronic communication with the electronic devices through the network 110. The server 105 can be located remotely with respect to the electronic devices. Examples of the network 110 include, but are not limited to, a Local Area Network (LAN), a Wireless Local Area Network (WLAN), a Wide Area Network (WAN), internet, and a Small Area Network (SAN).

In some embodiments, an electronic device, for example the electronic device 115a, can perform functions of the server 105.

A user of an electronic device, for example, the electronic device 115a logs into an online sharing platform. Log-in credentials, for example a user name and a password, is used for logging into the online sharing platform by the user. The online sharing platform is associated with the server 105 for storing a profile of the user. The profile of the user, in one example, includes contacts present in a network of the user, preferences of the user and personal information of the user. Preferences include sharing the content based on, but not limited to, a geographic location, time, a social relationship and an activity of the user.

In one example, the user of the electronic device 115a wishes to share content on the online sharing platform. Hence, the user logs into the online sharing platform using the log-in credentials. Upon logging into the online sharing platform, the user can view a web page including the profile, on the electronic device 115a. The web page further includes one or more sliders for defining the preferences of the user. The sliders are user interactive elements that are used to visually represent the preferences of the user in an ordered scale. The ordered scale can be continuous or discrete.

In one embodiment, various user interactive elements, for example a dial, can also be used for defining the preferences of the user instead of the sliders.

An indicator position present on each of the sliders can be altered for varying the preferences of the user. The indicator position on the sliders defines a group of contacts, based on a proximity range, permitted to view the content posted by the user. Further, the indicator position on the sliders is also used to indicate sharing of the content with respect to a location of the user, with respect to a time of posting the content by the user and with respect to an activity of the user.

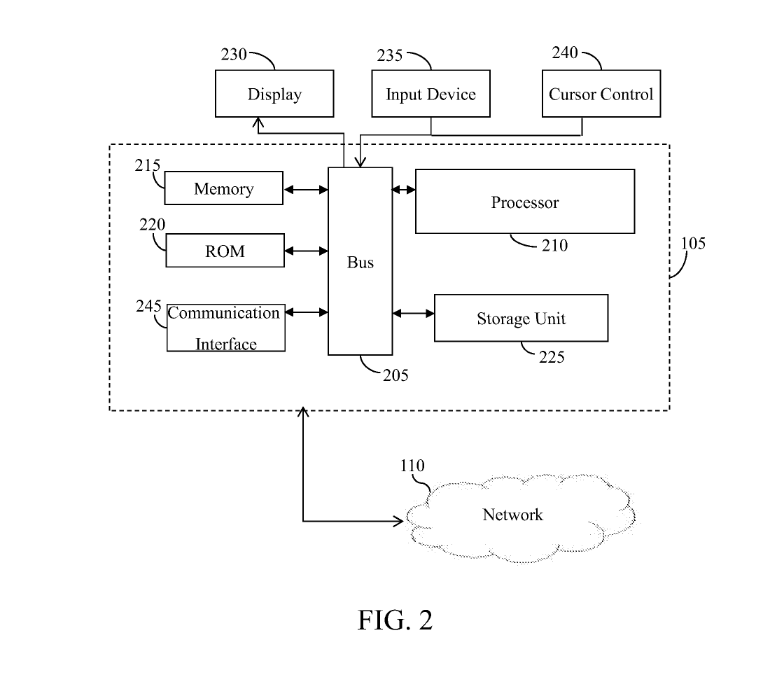

The server 105 is used to store the preferences of the user in addition to the profile of the user. Further, the server 105 is also used to determine the indicator positions on each of the sliders to enable sharing of the content by the user based on the proximity range. The server 105 including a plurality of elements is explained in detail in conjunction with FIG. 2.

FIG. 2 is a block diagram of a server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example information associated with preferences of a user.

The server 105 can be coupled via the bus 205 to a display 230, for example a cathode ray tube (CRT), for displaying content of the user. The input device 235, including alphanumeric and other keys, is coupled to the bus 205 for communicating information and command selections to the processor 210. Another type of user input device is the cursor control 240, for example a mouse, a trackball, or cursor direction keys for communicating direction information and command selections to the processor 210 and for controlling cursor movement on the display 230.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, such as the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that include the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. In any such implementation, the communication interface 245 sends and receives electrical, electromagnetic or optical signals that carry digital data streams representing various types of information.

The user can post the content on an online sharing platform. The processor 210 in the server 105 receives the content posted by the user. The user also alters indicator position, on one or more sliders, to define the preferences of the user. The processor 210 in the server 105 determines the indicator position on the sliders. The processor 210 in the server 105 then acquires the preferences of the user, based on the indicator position on the sliders, from the storage unit 225. The processor 210 further filters one or more contacts present in a network of the user for viewing the content based on a proximity range. Further, the processor 210 in the server 105 enables displaying the content, based on the preferences of the user, on the electronic device 115a.

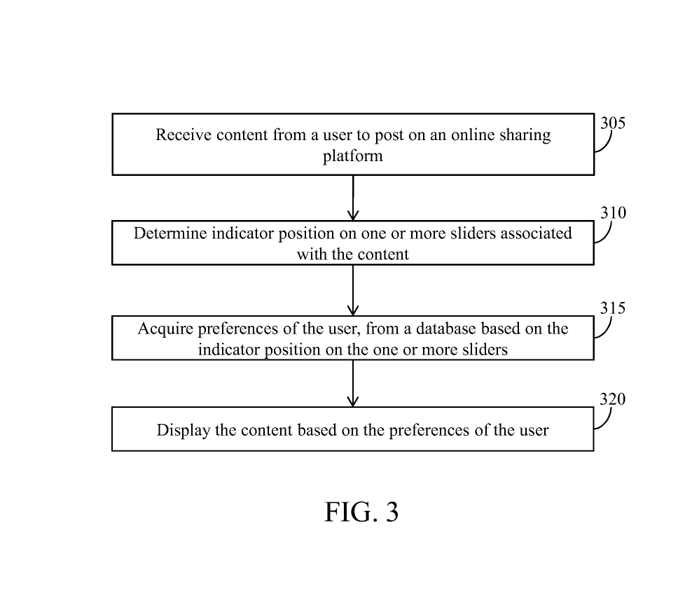

A method for implementing sharing of the content based on the preferences of the user is explained in detail in conjunction with FIG. 3.

FIG. 3 is a flowchart illustrating a method of managing sharing of content on an online sharing platform, in accordance with one embodiment.

At step 305, content is received from a user. Examples of the online sharing platform include, but are not limited to, networking sites, publication platforms, blogging sites and corporate email systems. Examples of the content include, but are not limited to, a location information, an image, a user status, a relationship information, a user interest, a news feed, a tweet, a message and an experience of the user. The content received from the user is posted on an online sharing platform homepage of the user. The content posted is thus viewed by multiple contacts present in a network of the user. The contacts, upon viewing, can therefore respond to the content posted by the user. In one example, the contacts can respond by making a comment to the content or by clicking an option.

At step 310, indicator position on one or more sliders associated with the content is determined. The sliders are user interactive elements that are used to represent preferences or a set of preferences of the user in an ordered scale. The ordered scale can be continuous or discrete. If the ordered scale is continuous, then the preferences are altered for each position of the indicator. If the ordered scale is discrete, then the preferences are altered for specific pre-defined positions of the indicator on the slider. The user can visually view the slider and manually move the indicator position on the sliders for altering the preferences. The preferences of the user, in one example, specifies a group of contacts permitted to view the content, the period of time to display the content and a location, on a web page of the online sharing platform, to display the content. Similarly, the sliders can also be used to specify various other preferences or a set of preferences of the user in real time.

In one embodiment, various user interactive elements can also be used for defining the preferences of the user. Examples of the user interactive elements include, but are not limited to, dials, accelerometers and biosensors.

When the content is posted, the user can vary the indicator position on the sliders based on the preferences. The group of contacts permitted to view the content is obtained based on a proximity range. The user shares the content based on the proximity range existing between the user and the group of contacts. The group of contacts that share the content of the user can be based on, but not limited to, a geographic proximity, a temporal proximity, a social proximity and an activity proximity. The geographic proximity defines the group of contacts that are geographically associated with the user. The temporal proximity defines a specific period of time for displaying the content. The social proximity defines the group of contacts that are socially associated with the user. The activity proximity defines the group of contacts that are associated with a similar activity of the user.

In one embodiment, various other proximities, for example, but are not limited to, multiple expressions of the user and psychological feelings of the user can be defined in real time by the user, to manage sharing of the content on the online sharing platform.

The homepage of the user includes one or more sliders. The sliders can be viewed, by the user, once the user gains access to the homepage. Examples of the sliders include, but are not limited to, a location slider, a time slider, a user contacts slider and an action slider. The location slider is used to share the content of the user with the contacts with respect to a location of the user. In one example, an indicator position on the location slider is positioned such that the contacts, present in the network of the user, located within 10 feet with respect to the location of the user are permitted to view the content. In another example, the user can alter the indicator position on the location slider such that the contacts located within half mile with respect to the location of the user are permitted to view the content. In yet another example, the user can alter the indicator position on the location slider such that the contacts located anywhere irrespective of the location of the user are permitted to view the content. The indicator position on the location slider represents the contacts permitted to view the content. The contacts are specified by the preferences of the user prior to posting the content.

The time slider is used to share the content of the user with the contacts with respect to a time of posting the content by the user. In one example, an indicator position on the time slider is positioned such that the content is required to be present on the online sharing platform homepage of the user for a particular time period from the time of posting. In another example, the user can alter the indicator position on the time slider such that the content is required to be present on the online sharing platform homepage, for one day from a day of posting. In yet another example, the user can alter the indicator position on the time slider such that the content is required to be present on the online sharing platform homepage of the user until the user wishes to remove the content. The indicator position on the time slider represents a period of time to display the content. The period of time is specified by the preferences of the user prior to posting the content.

The user contacts slider is used to define a group of contacts permitted to view the content posted by the user. In one example, an indicator position on the user contacts slider is positioned such that the content can be viewed by the contacts close to the user. The contacts close to the user are defined by the user prior to posting the content. In another example, the user can alter the indicator position on the user contacts slider such that content can be viewed by the contacts moderately close to the user. The contacts moderately close to the user are defined by the user prior to posting the content. In yet another example, the user can alter the indicator position on the user contacts slider such that content can be viewed by each of the contacts present in the network of the user. The indicator position on the user contacts slider represents the group of contacts permitted to view content. The contacts are specified by the preferences of the user prior to posting the content.

The action slider is used to share content with the contacts with respect to an activity, for example photography, of the user. In one example, an indicator position, on the action slider, is positioned such that the content can be viewed by the contacts performing an activity similar to the activity of the user. The contacts performing the activity that is similar to the activity of the user are defined by the user prior to posting the content. In another example, the user can alter the indicator position, on the action slider, such that the content can be viewed by the contacts performing an activity moderately similar to the activity of the user. The contacts performing the activity that is moderately similar to the activity of the user are defined by the user prior to posting the content. In yet another example, the user can alter the indicator position, on the action slider, such that the content can be viewed by each of the contacts present in the network of the user. The indicator position on the action slider represents the contacts permitted to view content. The contacts are specified by the preferences of the user prior to posting the content.

In one embodiment, the group of contacts for sharing the content using the sliders can be defined based on a continuous scale or a discrete scale. Examples of the continuous scale can include, but are not limited to, accelerometers and biosensors. Further, a set of sliders can be used depending on nature of the content the user wishes to share.

The user can vary the indicator positions of each of the sliders as mentioned above for displaying the content to specific contacts present in the network of the user.

At step 315, the preferences of the user are acquired based on the indicator position of the one or more sliders. The preferences of the user are acquired to permit specific contacts to access the content. The specific contacts can be based on the proximity range existing between the user and the contacts present in the network of the user. The preferences of the user based on the indicator position of each of the sliders are stored in a database associated with a storage unit, for example, the storage unit 225.

At step 320, the content is displayed based on the preferences of the user. The content thus displayed can be viewed by the specific contacts present in the network of the user. The specific contacts permitted for viewing the content information is obtained based on the indicator positions of each of the sliders as mentioned above.

In one embodiment, the user can pre-specify the preferences that are applied by default, whenever the user posts the content on the online sharing platform. The pre-specified preferences can be integrated along with the preferences represented by varying the indicator positions on the sliders, to manage sharing of the content on the online sharing platform.

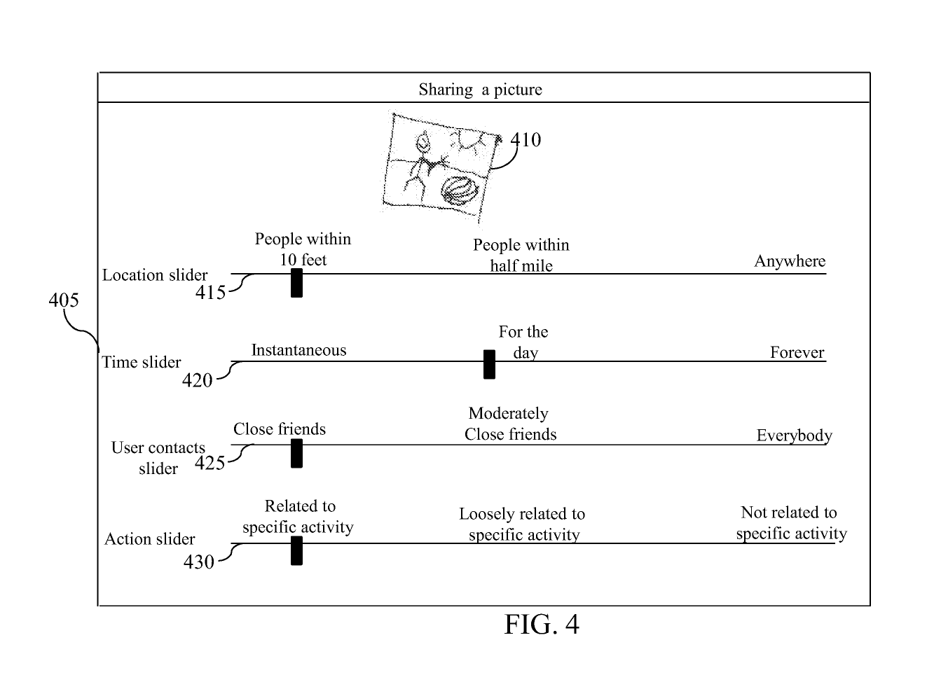

FIG. 4 illustrates an exemplary view to manage sharing of content on an online sharing platform by a user, in accordance with one embodiment.

FIG. 4 includes a homepage 405 of the online sharing platform, of a user, an image 410, a location slider 415, a time slider 420, a user contacts slider 425 and an action slider 430. The user wishes to share the image 410 with one or more contacts present in a network of the user on the online sharing platform.

The user now alters an indicator position on the location slider 415 to leftmost position, to permit the contacts located within 10 feet with respect to a location of the user for viewing the image 410. The location of the user is included in a user profile. The contacts located within 10 feet with respect to the location of the user are specified by the user and are further stored in a database associated with a server, for example, the server 105. The user can also subsequently alter the indicator position to the centre of the location slider 415, to permit the contacts located within half mile with respect to the location of the user for viewing the image 410. The contacts located within half mile with respect to the location of the user are specified by the user and are further stored in the database. Further, the user can also subsequently alter the indicator position on the location slider 415 to the rightmost position, to permit the contacts located anywhere irrespective of the location of the user for viewing the image 410. Specific contacts responsive to the indicator position on the location slider 415, for viewing the image 410, are specified by the preferences of the user and further stored in the database.

The user further alters an indicator position on the time slider 420 to the centre. The indicator position when located at the centre of the time slider 420 indicates that the image 410 can be viewed for one day by the contacts. The user can also subsequently alter the indicator position on the time slider 420 to the leftmost position, for instantaneous viewing of the image 410 by the contacts. The user can also subsequently alter the indicator position on the time slider 420, to the rightmost position, for allowing the image 410 to be present on the online sharing platform homepage 405 that can always be viewed by the contacts. Enabling the image 410 to be displayed for a time period responsive to the indicator position on the time slider 420 is specified by the preferences of the user and is further stored in the database prior to posting the image 410.

Further, the user alters an indicator position on the user contacts slider 425 to the leftmost position, to permit the contacts that are close friends of the user to view the image 410. The contacts that are close friends of the user are specified by the user and are further stored in the database. The user can also subsequently place the indicator position to the centre of the user contacts slider 425, to permit the contacts that are moderately close friends of the user to view the image 410. The contacts that are moderately close friends are specified by the user and are further stored in the database. Further, the user can also subsequently alter the indicator position on the user contacts slider 425 to the rightmost position, to permit all the contacts present in the network of the user to view the image 410. Specific contacts responsive to the indicator position on the user contacts slider 425, for viewing the image 410, are specified by the preferences of the user and further stored in the database.

Furthermore, the user alters an indicator position on the action slider 430 to the rightmost, to permit the contacts that are associated with any activity irrespective of a specific activity, of the user, to view the image 410. The user can also subsequently alter the indicator position to the centre of the action slider 430, to permit the contacts that are moderately related to the specific activity, of the user, to view the image 410. The contacts that are moderately related to the specific activity are specified by the user and are further stored in the database. Further, the user can also subsequently alter the indicator position on the action slider 430 to the rightmost position, to permit each of the contacts, present in the network of the user, to view the image 410. Specific contacts responsive to the indicator position on the activity slider 430, for viewing the image 410, are specified by the preferences of the user and further stored in the database.

The image 410 is then displayed to the specific contacts based on the indicator position of each of the sliders mentioned above. Hence, the sharing of the image 410 is managed by varying the indicator positions of each of the sliders mentioned above. Further, pre-specified preferences can be integrated along with the preferences represented by varying the indicator positions on the sliders mentioned above, to manage sharing of the content on the online sharing platform.

The method specified in the present disclosure enables a user to manage sharing of content on an online sharing platform with one or more contacts based on a proximity range. The method enables an easy displacement of indicator position on one or more sliders from left through right, by the user, for defining the proximity range existing between the user and each of the contacts. The user can visually view the slider, present on an online sharing platform homepage of the user, and set a preference by displacing the sliders, from left through right. Thereby, time spent on performing multiple changes to a privacy setting present on different web page of the online sharing platform is saved. Further, by displacing the sliders from left through right, the user can instantly set boundaries to limit sharing the content to the specific contacts.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method for managing sharing of content on an online sharing platform, the method comprising:
receiving the content from a user to post on the online sharing platform;
determining indicator position on one or more sliders associated with the content;
acquiring preferences of the user, from a database based on the indicator position on the one or more sliders; and
displaying the content based on the preferences of the user.

2. The method as claimed in claim 1, wherein the content comprises at least one of a location information, an image, a user status and a relationship information.

3. The method as claimed in claim 1, wherein the preferences of the user are altered by varying the indicator position on the one or more sliders.

4. The method as claimed in claim 1, wherein the one or more sliders comprise at least one of a location slider, a time slider, a user contacts slider and an action slider.

5. The method as claimed in claim 4, wherein the location slider is used to share the content with respect to a location of the user, the time slider is used to share the content with respect to a time of posting the content by the user, the user contacts slider is used to define a group of contacts from a plurality of contacts to share the content and, the action slider is used to share the content with respect to an activity of the user.

6. The method as claimed in claim 1, wherein the preferences of the user comprises at least one of a group of contacts from a plurality of contacts to share the content, a period of time to display the content to the group of contacts, and a location on a web page of the online sharing platform to display the content for viewing by the group of contacts.

7. The method as claimed in claim 6, wherein the group of contacts is defined based on a proximity range.

8. The method as claimed in claim 7, wherein the proximity range comprises at least one of a geographic proximity, a temporal proximity, a social proximity and an activity proximity.

9. A computer program product stored on a non-transitory computer-readable medium that when executed by a processor, performs a method of managing sharing of content on an online sharing platform, the method comprising:
receiving the content from a user to post on the online sharing platform;
determining indicator position on one or more sliders associated with the content;
acquiring preferences of the user, from a database based on the indicator position on the one or more sliders; and
displaying the content based on the preferences of the user.

10. The computer program product as claimed in claim 9, wherein the content comprises at least one of a location information, an image, a user status and a relationship information.

11. The computer program product as claimed in claim 9, wherein the preferences of the user is altered by varying the indicator position on the one or more sliders.

12. The computer program product as claimed in claim 9, wherein the one or more sliders comprise at least one of a location slider, a time slider, a user contacts slider and an action slider.

13. The computer program product as claimed in claim 12, wherein the location slider is used to share the content with respect to a location of the user, the time slider is used to share the content with respect to a time of posting the content by the user, the user contacts slider is used to define a group of contacts from a plurality of contacts to share the content and, the action slider is used to share the content with respect to an activity of the user.

14. The computer program product as claimed in claim 9, wherein the preferences of the user comprises at least one of a group of contacts from a plurality of contacts to share the content, a period of time to display the content to the group of contacts, and a location on a web page of the online sharing platform to display the content for viewing by the group of contacts.

15. The computer program product as claimed in claim 14, wherein the group of contacts is defined based on a proximity range.

16. The computer program product as claimed in claim 15, wherein the proximity range comprises at least one of a geographic proximity, a temporal proximity, a social proximity and an activity proximity.

17. A system for managing sharing of content on an online sharing platform, the system comprising:
an electronic device that enables a user to provide the content using one or more sliders;
a communication interface in electronic communication with the electronic device;
a memory that stores instructions; and
a processor responsive to the instructions to
receive the content from the user;
determine indicator position on one or more sliders associated with the content;
acquire preferences of the user based on the indicator position on the one or more sliders; and
display the content based on the preferences of the user on the electronic device.

18. The system as claimed in claim 17, wherein the content comprises at least one of a location information, an image, a user status and a relationship information.

19. The system as claimed in claim 17, wherein the preferences of the user is altered by varying the indicator position on the one or more sliders.

20. The system as claimed in claim 17, wherein the preferences of the user defines at least a group of contacts from a plurality of contacts to share the content, a period of time to display the content to the group of contacts, and a location of a web page on the online sharing platform to display the content for viewing by the group of contacts.
